(19) United States
(12) Patent Application Publication
(10) Pub. No.: US 2014/0271280 A1
(43) Pub. Date: Sep. 18, 2014

(54) PUMP MOTOR

(71) Applicant: MERKLE-KORFF INDUSTRIES, INC., Elk Grove Village, IN (US)

(72) Inventors: Bruce Ley, Ossian, IN (US); Justin Mumaw, Fort Wayne, IN (US); Justin Anteau, St. Louis, MO (US)

(73) Assignee: MERKLE-KORFF INDUSTRIES, INC., Elk Grove Village, IN (US)

(21) Appl. No.: 14/216,594

(22) Filed: Mar. 17, 2014

Related U.S. Application Data
(60) Provisional application No. 61/789,741, filed on Mar. 15, 2013.

(51) Int. Cl. F04D 13/02; H02K 5/124; H02K 5/10

(52) U.S. Cl. CPC F04D 13/024; H02K 5/10; H02K 5/124
USPC 417/420; 310/88; 310/43

(57) ABSTRACT

An electric pump motor is provided. The motor includes a stator assembly including a magnetic stator component and an overmolded stator casing sealingly encapsulating the magnetic stator component. A rotor assembly that is rotatable about an axis includes a rotor shaft extending along the axis, a magnetic rotor component, and an overmolded rotor casing fixedly interconnecting the rotor shaft and magnetic rotor component. The rotor shaft is connected to an impeller that imparts a thrust load on the rotor shaft. The rotor and stator assemblies are configured so that the magnetic components induce a solenoid force on the rotor shaft opposite the thrust load.

### CROSS REFERENCE TO RELATED APPLICATION

This application claims priority of U.S. Provisional Patent Application Ser. No. 61/789,741, filed Mar. 15, 2013, which is hereby incorporated in its entirety by reference herein.

### BACKGROUND OF THE INVENTION

1. Field of the Invention

The present invention relates generally to motors. More specifically, the present invention concerns a motor particularly suitable for wet rotor configurations.

2. Discussion of Prior Art

Those ordinarily skilled in the art will appreciate that motors are used in a variety of applications, including, but not limited to, driving liquid pumps. Safety standards and overall functionality of liquid pump motors require that motor components are protected from liquid exposure. Liquid pump motors also require regular maintenance on the bearings due to thrust load induced by the impeller. It is generally desirable to design a liquid pump motor that is sealed from direct contact with liquids and to reduce impeller induced thrust load.

### SUMMARY OF THE INVENTION

According to one aspect of the invention, a pump assembly is provided. The pump assembly comprises a pump and a pump motor. The pump includes a rotatable impeller housed within a pump chamber. The pump motor includes a rotor assembly and a stator assembly. The rotor assembly includes a rotor shaft that extends along a rotational axis and is connected to the impeller for rotational movement therewith, with rotation of the impeller imparting a thrust load on the rotor shaft in a first axial direction. The rotor assembly includes a magnetic rotor component that is fixed to the rotor shaft for rotational movement therewith. The stator assembly includes a magnetic stator component. The magnetic components cooperatively define a magnetic zero condition, in which magnetic fields generated by the magnetic components exert substantially no axial force on the rotor shaft. The rotor and stator assemblies are configured so that the magnetic components are out of the magnetic zero condition during motor operation, with the magnetic fields thereby inducing a solenoid force on the rotor shaft in a second axial direction opposite the first axial direction.

According to another aspect of the present invention, a motor for powering a liquid pump, wherein the pump includes a rotatable impeller housed within a pump chamber, is provided. The motor comprises a rotor assembly and a stator assembly. The rotor assembly is rotatable about an axis and is connectable to the impeller. The stator assembly includes a magnetic stator component and an overmolded stator casing sealingly encapsulating the magnetic stator component.

According to another aspect of the present invention, a motor is provided. The motor is comprised of a stator assembly and a rotor assembly. The rotor assembly is rotatable about an axis relative to the stator assembly. The rotor assembly includes a rotor shaft extending along the axis, a magnetic rotor component, and an overmolded rotor casing fixedly interconnecting the rotor shaft and magnetic rotor component.

This summary is provided to introduce a selection of concepts in simplified form. These concepts are further described below in the detailed description of the preferred embodiments. This summary is not intended to identify key features or essential features of the claimed subject matter, nor is it intended to be used to limit the scope of the claimed subject matter.

Various aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective view of a pump assembly constructed in accordance with a preferred embodiment of the present invention, wherein the pump assembly includes a pump and a motor;

FIG. 2 is an enlarged perspective view of the motor shown in FIG. 1, particularly showing the openings in the motor endshield for interconnecting the pump chamber and rotor chamber;

FIG. 3 is a top view of the motor depicted in FIGS. 1 and 2;

FIG. 4 is a partially sectioned perspective view of the motor of FIGS. 1-3, with the endshield and rotor assembly removed;

FIG. 5 is a partially sectioned bottom perspective view of the motor of FIGS. 1-4, with the endshield removed;

FIG. 6 is a partially sectioned perspective view of the motor;

FIG. 7 is a side cross-sectional view taken along line 7-7 of FIG. 3;

FIG. 7a is an enlarged cross-sectional view of just the rotor assembly, as depicted in FIG. 7;

FIG. 8 is a cross-sectional view taken along line 8-8 of FIG. 7;

FIG. 8a is an enlarged, fragmented view of FIG. 8, particularly showing features of the rotor assembly;

FIG. 9 is a cross-sectional view taken along 9-9 of FIG. 3, illustrating the axially offset centers of the magnetic components;

FIG. 9a is an enlarged, fragmented view of the motor as depicted in FIG. 9;

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

With initial reference to FIG. 1, a pump assembly 20 constructed in accordance with the principles of an embodiment of the present invention is depicted for use in various applications. The illustrated pump assembly 20 comprises a motor 22 coupled to a pump 23. The pump 23 is shown somewhat schematically and generally includes a pump chamber 24 and a rotatable pump impeller 26, as will be readily understood by one of ordinary skill in the art. The motor 22 powers the impeller 26. Those of ordinary skill in the art will appreciate that the pump 23 may be alternatively configured without departing from the spirit of the invention. Moreover, according to certain aspects of the present invention, the motor 22 may be used in applications not including a pump (particularly other wet rotor applications). The motor 22 presents a plurality of mounting holes 28 for receiving fasteners (not shown) secured to the pump chamber 24, although various connecting structures may be alternatively used without departing from the teachings of the present invention.

As noted, the pump assembly 20 has particular utility when the motor 22 is configured to provide driving power to an impeller 26 in a liquid pump chamber 24, such as a pool pump chamber, and is used as a pool pump motor. The structure and operation of the liquid pump chamber 24 may be generally conventional in nature and need not be described in further detail here.

The motor 22 is designed to allow liquid to flow between the pump chamber 24 and various motor components as further discussed below. This “wet” design is useful for facilitating cooling of the motor components (e.g., the stator and rotor), particularly for liquid pump applications. Referring to the drawings, first to FIGS. 2 and 3, the motor 22 presents an open end 30 and a closed end 32. The motor 22 broadly includes a stator assembly 34, a rotor assembly 36 rotatable about an axis, and an endshield 38. The stator assembly 34 presents a seal plate 40 configured to connect the motor 22 to the pump chamber 24. The endshield 38 presents an opening 42 into the stator assembly 34 and further presents a plurality of circumferentially spaced mounting holes 44 for receiving fasteners (not shown) secured to the pump chamber 24. In the illustrated embodiment, the seal plate 40 is interposed between the endshield 38 and the pump chamber 24 when the motor 22 and pump chamber 24 are in a connected relationship. However, it is alternatively suitable for the endshield 38 and seal plate 40 to have a different configuration than shown. For example, if desired, the endshield may be radially smaller than the seal plate, or the endshield may be embedded within the seal plate. The motor 22 also includes a wiring terminal 46 for providing electrical power to at least some parts of the motor 22 as described in more detail below.

Turning now to FIG. 4, the stator assembly 34 includes a magnetic stator component 48 and an overmolded stator casing 50 that sealingly encapsulates the magnetic stator component. The magnetic stator component 48 includes a stator core 52 and windings 54 wrapped around the stator core. The windings 54 are preferably overmolded with a winding casing 57 that at least substantially encapsulates the windings. Although the illustrated embodiments generally include a two-part mold, such that the overmold of the winding casing 57 are independent the overmold of the stator casing 50, a single overmold used for encapsulating the windings and magnetic stator component may be considered for use within the scope of this invention. In the illustrated embodiment, the core 52 is formed of steel laminations and the windings 54 are formed of aluminum or copper wire. However, the principles of the present invention are applicable to other suitable magnetic stator component designs. For example, such other suitable designs may include the core comprising a solid steel body, an alternative pole/slot configuration, the use of permanent magnets rather than electromagnetic winding arrangements, etc.

As is somewhat conventional and readily appreciated by one of ordinary skill in the art, the windings 54 are coupled to wiring 55 that serves as a lead for pulling current from a main power source (not shown). The wiring 55 extends through the casing 50 and presents a terminal 46 for connecting the power source. The casing 50 preferably provides a sealed wiring port 56, such that the terminal 46 or wiring can extend therethrough without concern of liquid entry. In a preferred embodiment, the wiring 55 is comprised of a conductive material, such as copper.

The stator casing 50 is generally comprised of an injection-molded thermoplastic blend of polyphenylene oxide (PPO) and polystyrene (PS) resin. The winding overmold 57 is generally comprised of a thermoplastic polyester resin. However, any material suitable for meeting insulation and/or pump requirements may be considered for use for the overmolds within the scope of this invention. The preferred stator casing material is substantially rigid to define a structural case for the motor. More specifically, the stator casing 50 defines inner and outer surfaces 59,60 of the motor 22, with the magnetic stator component 48 being embedded within the casing 50. In this manner, the magnetic stator component 48 is sealed from exposure to liquid from both within and outside the motor 22.

More particularly, the stator casing 50 defines a rotor chamber 58 that generally receives at least a portion of a rotor assembly 36 therein. In the preferred embodiment, the rotor chamber 58 is fluidly connectable to the pump chamber 24 such that liquid can fill the rotor chamber 58 around the rotor assembly 36. At the open end 30 of the motor, the stator casing 50 defines an open end 61 of the rotor chamber. The stator casing 50 presents a motor seal plate 40 adjacent the open end 61 of the rotor chamber.

The motor seal plate 40 is configured to connect the motor 22 to the pump chamber 24. The motor seal plate 40 presents a plurality of mounting holes 62 for receiving fasteners (not shown) secured to the pump chamber 24, although various connecting structures may be alternatively used without departing from the teachings of the present invention.

In some embodiments, the stator casing may include a freeze plug (not shown). The freeze plug generally functions as a corking mechanism that plugs a channel (not shown) between the rotor chamber 58 and the environment external to stator case 50. In the event of liquid expansion within the rotor chamber (e.g., due to liquid freezing), the freeze plug releases pressure acting on the stator casing 50 to prevent expansion-related damage, such as casing cracking.

Turning now to FIG. 5, the stator casing 50 at the closed end 32 of the motor defines a closed end 64 of the rotor chamber opposite the open end 61 thereof. The stator casing 50 presents a bearing housing 66 adjacent the closed end 64 of the rotor chamber. A bearing assembly 68 is fixed within the bearing housing 66 and rotatably supports the rotor assembly 36. The bearing assembly 68 preferably comprises a ball bearing having at least one flat 70 defined on its outer circumferential face. In the preferred embodiment, the flat 70 is defined within a circumferential groove of the bearing assembly 68, with a rib 71 of the casing formed during the overmolding process extending into the groove to prevent relative rotation and axial movement between the bearing assembly 68 and stator casing 50. In the illustrated embodiment the bearing housing has two axially-aligned grooves, although just one or more than two grooves of varying alignment may be permitted.

For some aspects, a magnetic stator component 48 need not be encased. In fact, the motor 22 could have an open design such that the encasing or “waterproofing” of the magnetic stator component 48 is not required. For example, the magnetic stator component 48 may be at least partially exposed (e.g., vented or substantially open) to the environment when operating in a “dry” environment. Therefore, in dry applications, exposure of liquids to the magnetic stator component 48 may not be of particular concern.

As shown in FIG. 6, the preferred rotor assembly 36 includes a rotor shaft 72 extending along the axis, a magnetic rotor component 74, and an overmolded rotor casing 76 fixedly interconnecting the rotor shaft and magnetic rotor component. More preferably, the rotor casing 76 sealingly encapsulates the magnetic rotor component 74, although such “waterproofing” of the magnetic rotor component 74 is not required for all aspects of the present invention. The rotor shaft 72 projects axially beyond the ends of the rotor casing 76. The magnetic rotor component 74 includes a rotor core 78 having a generally toroidal shape. The illustrated embodiments show a permanent magnet rotor core 78, wherein a plurality of circumferentially spaced permanent magnets 80 are fixed to the core. The rotor core 78 is preferably formed of steel. However, various rotor configurations may be considered without departing from the scope of some aspects of the invention. For example, the rotor assembly could alternatively have an electromagnetic configuration, with windings being wrapped around the core. In addition, the rotor assembly need not have a steel core, meaning the magnets could be otherwise supported (e.g., by just the casing). If necessary, pole segments or a steel backing ring could be used with a rotor that does not have a core.

In the illustrated embodiment, the rotor core 78 and rotor shaft 72 cooperatively define an annular gap 82. The rotor casing 76 fills the annular gap 82. As shown in FIGS. 6-8, the rotor shaft 72 has an outer circumferential face 84 and the rotor core has an inner circumferential face 86, with the annular gap 82 being defined between the faces. In the illustrated embodiment, the outer circumferential face 84 of the rotor shaft has two flats 88 defined therein. The rotor casing 76, preferably comprised of an injection-molded thermoplastic blend of polyphenylene oxide (PPO) and polystyrene (PS) resin, sealingly encapsulates the magnetic rotor component 74 and fills the annular gap 82 such that the casing 76 securely fixes the shaft 72 and magnetic rotor component 74 to one other while preventing relative rotation therebetween. As will be readily appreciated by one of ordinary skill in the art, the flats 88 on the rotor shaft outer circumferential face 84 assist with preventing relative rotation between the rotor shaft 72 and the magnetic rotor component 74. Furthermore, if desired, the magnetic rotor component may alternatively or additionally be provided with flats for further restricting relative rotation between the rotor shaft 72 and magnetic rotor component 74. Yet further, alternative configurations may be provided to assist with preventing relative rotation between the rotor shaft 72 and rotor component 74. For example, on or both of the shaft 72 and component 74 could have a polygonal shape or have a toothed or corrugated surface.

As is somewhat conventional and readily appreciated by one of ordinary skill in the art, liquid pump motors generally require the use of multiple sealing components including, but not limited to, a rotating wear seal, a motor slinger, and a motor seal. The use of overmolding eliminates the need for multiple sealing components. Elimination of the rotating seal further allows for increased motor tolerances for pump impeller axial location, because rotating wear seal pressure no longer needs to be critically controlled. More specifically, the use of overmolding foregoes the need for a motor shaft seal, a motor shaft water slinger, and a pump ceramic seal, which is a wear and maintenance part. The overmolded design integrates all of the parts in a liquid pump motor from the seal plate to the motor, thereby reducing material, assembly time and complexity, cost, and the need for seals. Overmolding further improves moisture resistance and protects motor windings from the environment.

The rotor shaft presents opposing axial ends. The first axial end 90 is rotatably supported by the bearing assembly 68 adjacent the closed end of the rotor chamber 64. The endshield 38 is fixed relative to the seal plate 40 and presents a bearing housing 94 adjacent to and coaxially aligned with the endshield opening 42. A bearing assembly 96 is fixed within the bearing housing 94 and rotatably supports a second axial end of the rotor shaft 92. The bearing assembly 96 preferably comprises a ball bearing having at least one flat 98 defined on its outer circumferential face. In the preferred embodiment, the flat 98 is defined within a circumferential groove of the bearing assembly 96, with a rib 99 of the endshield bearing housing 94 extending into the groove to prevent relative rotation and axial movement between the bearing assembly 96 and endshield 38. In the illustrated embodiment the bearing housing has two axially-aligned grooves, although just one or more than two grooves of varying alignment may be permitted. The second axial end 92 projects axially outward from the open end of the rotor chamber 61, through the bearing assembly 96, and into the pump chamber 24. The second axial end of the rotor shaft 92 supports the impeller 26 for rotational movement therewith. As will be appreciated by one of ordinary skill in the art, the impeller 26 can use various methods of attaching to the rotor shaft 92 that are within the scope of the invention.

The endshield opening 42 is preferably defined by an annular spoked opening. The rotor chamber 58 is thereby fluidly coupled to the pump chamber 24. Therefore, the rotor casing 76 overlying the magnetic rotor component 74, part of the shaft 72, and the bearing assemblies 68,96 are exposed to the liquid. The “wet” configuration of the motor 22 and the use of the overmolded stator and rotor casings 50,76 eliminates liquid induced corrosion, and further eliminates the need for multiple sealing components. Elimination of the rotating seal further allows for increased motor tolerances for pump impeller axial location, because rotating wear seal pressure no longer needs to be critically controlled. More specifically, the “wet” configuration and the use of overmolded casings forgoes the need for a motor shaft seal, a motor shaft water slinger, and a pump ceramic seal, which is a wear and maintenance part.

As will be readily appreciated by one of ordinary skill in the art, operation of a motor, particularly under load, can lead to premature breakdown of the bearings. Load forces lead to decreased motor efficiency and increased load on the rotor bearings. As can be appreciated by one of ordinary skill in the art, motors are generally designed so that the rotor and stator are aligned at a “magnetic zero condition.” In other words, the magnetic element of the stator and the magnetic component of the rotor are aligned such that axial and radial reluctance between the magnetic component and magnetic element are in a minimum reluctance configuration. Maximum motor efficiency is generally achieved when the rotor and stator are in such a configuration. The magnetic zero condition for the illustrated motor 22 is referenced by the line 100 (see FIGS. 9 and 9a). The slightest offset between the rotor and stator, away from the magnetic zero condition, can lead to magnet induced torque drag or “solenoid forces” that try to bring the rotor and stator back into the magnetic zero condition. As can be further appreciated by one of ordinary skill in the art, rotation of the impeller 26 will impart an axial thrust load on the rotor shaft 72 and thus the bearing assemblies 68,96. The thrust load, as a result of axial thrust forces from the impeller 26, necessitates a means to reduce thrust load on the rotor assembly 36 and bearings 96. The minimization of a thrust load on the rotor created by the impeller, in turn, reduces wear on the bearings and increases motor efficiency.

Rotation of the impeller 26 imparts a thrust load on the rotor shaft 72 in a first axial direction D1. The rotor and stator assemblies 36,34 are configured so that the magnetic components 48,74 are out of the magnetic zero condition 100 during motor operation, with the magnetic fields thereby inducing a solenoid force on the rotor shaft 72 in a second axial direction D2 opposite the first axial direction D1. Thrust load forces can be substantially offset by configuring the rotor and stator assemblies 36,34 such that the solenoid forces acting between the assemblies are substantially equal to the thrust load, as preferred.

In the illustrated embodiment, each of the magnetic components 48,74 present an axial length and a center located midway along the length. The magnetic components 48,74 are generally symmetric about the center. The magnetic components are axially offset 102 so that the centers thereof are axially spaced from one another. With the preferred embodiment, this offset (as represented by line 102 in FIGS. 9 and 9a) provides the desired counteraction to the thrust load. However, this counteraction may be alternatively provided without departing from the spirit of the present invention. For example, changes may be made to the construction of the magnetic components 48,74 themselves to create the desired solenoid effect. More particularly, the magnets 80, cores 52,78, and/or windings 54 may be configured or relatively positioned to create the desired solenoid effect. In the illustrated embodiment, the magnetic stator component 48 is configured so that its axial length is greater than the axial length of the magnetic rotor component 74, although similar component length may alternatively be provided.

As can be appreciated by one of ordinary skill in the art, a substantially vertically oriented motor will have additional gravitational forces acting axially on the rotor assembly 36, as opposed to a substantially horizontally oriented motor having zero to minimal gravitational forces acting on the rotor assembly 36. In a substantially vertical orientation, a gravitational force acts axially downwardly on the rotor assembly 36. Thus, to offset the impeller 26 induced thrust load, the rotor and stator assemblies 36,34 are configured such that the solenoid force is substantially equal to a negative vector sum of the thrust load and the gravitational force acting on the rotor shaft 72. In a vertically upright motor as illustrated in FIG. 9, assuming an impeller (not shown) induces a thrust load axially away from the motor 22, the thrust load is opposite the gravitational force.

One of ordinary skill in the art would appreciate that the calculations for determining the solenoid forces for offsetting the thrust load, with or without gravitational forces, would be elementary in single-speed motor configurations. However, when dealing with variable speed motor configurations, the rotor and stator assemblies need to be configured so that the solenoid forces would maximize efficiency throughout the entire range of motor speeds. In a preferred embodiment, a maximum speed and a minimum speed would create a maximum thrust load and minimum thrust load, respectively. Therefore, in a preferred embodiment for variable speed motors, the solenoid force would be substantially equal to one-half of the negative vector sum of the maximum thrust load and the minimum thrust load.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A pump assembly comprising:
a pump including a rotatable impeller housed within a pump chamber; and
a pump motor including—
a rotor assembly including a rotor shaft that extends along a rotational axis and is connected to the impeller for rotational movement therewith, with rotation of the impeller imparting a thrust load on the rotor shaft in a first axial direction,
said rotor assembly including a magnetic rotor component that is fixed to the rotor shaft for rotational movement therewith; and
a stator assembly including a magnetic stator component,
said magnetic components cooperatively defining a magnetic zero condition, in which magnetic fields generated by the magnetic components exert substantially no axial force on the rotor shaft,
said rotor and stator assemblies being configured so that the magnetic components are out of the magnetic zero condition during motor operation, with the magnetic fields thereby inducing a solenoid force on the rotor shaft in a second axial direction opposite the first axial direction.

2. The pump assembly as claimed in claim 1,
said solenoid force being substantially equal to the thrust load, such that the thrust load force is substantially offset by the solenoid force.

3. The pump assembly as claimed in claim 1,
each of said magnetic components presenting an axial length and a center located midway along the length,
each of said magnetic components being generally symmetric about the center,
said magnetic components being axially offset so that the centers thereof are axially spaced from one another.

4. The pump assembly as claimed in claim 3,
said magnetic stator component being configured so that the axial length thereof is greater than that of the magnetic rotor component.

5. The pump assembly as claimed in claim 1,
said motor being oriented so that the rotational axis is at least substantially vertical, with a gravitational force acting axially downwardly on the rotor shaft,
said solenoid force being substantially equal to a negative vector sum of the thrust load and the gravitational force acting on the rotor shaft.

6. The pump assembly as claimed in claim 5,
said thrust load being opposite the gravitational force.

7. The pump assembly as claimed in claim 1,
said motor being a variable speed motor having a maximum speed and a minimum speed,
said maximum speed inducing a maximum thrust load and said minimum speed inducing a minimum thrust load,
said solenoid force being substantially equal to one-half a negative vector sum of the maximum thrust load and the minimum thrust load.

8. The pump assembly as claimed in claim 1,
said stator assembly including an overmolded stator casing sealingly encapsulating the magnetic stator component.

9. The pump assembly as claimed in claim 8,
said rotor assembly including an overmolded rotor casing fixedly interconnecting the rotor shaft and magnetic rotor component.

10. The pump assembly as claimed in claim 9,
said stator assembly generally circumscribing the rotor assembly,
said stator casing defining a rotor chamber that generally receives at least a portion of the rotor assembly therein,
said rotor chamber being fluidly connected to the pump chamber such that liquid fills the rotor chamber around the rotor assembly.

11. The pump assembly as claimed in claim 10,
said rotor shaft extending outwardly from the rotor chamber for connection to the impeller,
said magnetic rotor component being located within the rotor chamber,
said rotor casing sealingly encapsulating the magnetic rotor component.

12. The pump assembly as claimed in claim 1,
said rotor assembly including an overmolded rotor casing fixedly interconnecting the rotor shaft and magnetic rotor component.

13. The pump assembly as claimed in claim 1,
said magnetic stator component including a stator core and windings wrapped around the stator core.

14. The pump assembly as claimed in claim 1,
said magnetic rotor component including a rotor core that has a generally toroidal shape,
said magnetic rotor component including a plurality of circumferentially spaced permanent magnets fixed to the core.

15. A motor for powering a liquid pump, wherein the pump includes a rotatable impeller housed within a pump chamber, said motor comprising:
a rotor assembly rotatable about an axis,
said rotor assembly being connectable to the impeller; and
a stator assembly including a magnetic stator component and an overmolded stator casing sealingly encapsulating the magnetic stator component.

16. The motor as claimed in claim 15,
said stator assembly generally circumscribing the rotor assembly,
said stator casing defining a rotor chamber that generally receives at least a portion of the rotor assembly therein.

17. The motor as claimed in claim 16,
said rotor chamber being fluidly connectable to the pump chamber such that liquid fills the rotor chamber around the rotor assembly.

18. The motor as claimed in claim 17,
said rotor assembly including a rotor shaft extending along the axis,
said rotor shaft extending outwardly from the rotor chamber for connection to the impeller,
said rotor assembly including a magnetic rotor component located within the rotor chamber,
said rotor assembly including an overmolded rotor casing fixedly interconnecting the rotor shaft and magnetic rotor component,
said rotor casing sealingly encapsulating the magnetic rotor component.

19. The motor as claimed in claim 17,
said stator case defining an open end of the rotor chamber,
said stator casing presenting a motor seal plate adjacent the open end of the rotor chamber,
said motor seal plate being configured to connect the motor to the pump.

20. The motor as claimed in claim 19,
said rotor assembly including a rotor shaft extending along the axis,
said rotor shaft projecting axially outward from the open end of the rotor chamber,
said rotor shaft being configured to support the impeller for rotational movement therewith;
an endshield fixed relative to the seal plate, with the rotor shaft extending through the endshield; and
a first bearing assembly rotatably supporting the rotor shaft on the endshield.

21. The motor as claimed in claim 20,
said endshield presenting an opening for intercommunicating the rotor chamber and pump chamber.

22. The motor as claimed in claim 20,
said stator casing defining a closed end of the rotor chamber opposite the open end thereof,
said stator casing presenting a bearing housing adjacent the closed end of the rotor chamber; and
a second bearing assembly being fixed within the bearing housing and rotatably supporting the rotor shaft.

23. The motor as claimed in claim 15,
said stator casing comprising an injection-molded thermoplastic blend of polyphenylene oxide and polystyrene resin.

24. The motor as claimed in claim 15,
said magnetic stator component including a stator core and windings wrapped around the stator core.

25. The motor as claimed in claim 24,
said stator assembly including an overmolded winding casing at least substantially sealingly encapsulating the windings.

26. The motor as claimed in claim 24,
said stator assembly including wiring coupled to the windings,
said stator casing including a sealed wiring port through which the wiring extends.

27. A motor comprising:
a stator assembly; and
a rotor assembly rotatable about an axis relative to the stator,
said rotor assembly including—
a rotor shaft extending along the axis,
a magnetic rotor component, and
an overmolded rotor casing fixedly interconnecting the rotor shaft and magnetic rotor component.

28. The motor as claimed in claim 27,
said rotor casing sealingly encapsulating the magnetic rotor component.

29. The motor as claimed in claim 28,
said rotor casing presenting opposite axial ends,
said shaft projecting axially beyond the ends of the rotor casing.

30. The motor as claimed in claim 29,
said magnetic rotor component including a rotor core that has a generally toroidal shape,
said magnetic rotor component including a plurality of circumferentially spaced permanent magnets fixed to the core.

31. The motor as claimed in claim 30,
said rotor core and rotor shaft cooperatively defining an annular gap therebetween.

32. The motor as claimed in claim 31,
said rotor casing filling the annular gap.

33. The motor as claimed in claim 32,
said rotor shaft having an outer circumferential face, and said rotor core having an inner circumferential face, with the annular gap being defined between the faces,
at least one of said circumferential faces having at least one flat defined therein.

34. The motor as claimed in claim 27,
said rotor casing comprising an injection-molded thermoplastic blend of polyphenylene oxide (PPO) and polystyrene (PS) resin.

35. The motor as claimed in claim 27,
said magnetic rotor component being generally ring-shaped, with the rotor shaft extending through the magnetic rotor component,
said magnetic rotor component and rotor shaft cooperatively defining an annular gap therebetween,
said rotor casing filling the annular gap.

36. The motor as claimed in claim 35,
said rotor casing sealingly encapsulating the magnetic rotor component.

37. The motor as claimed in claim 27,
said stator assembly including a magnetic stator component and an overmolded stator casing sealingly encapsulating the magnetic stator component.
